(19) United States
(12) Patent Application Publication
(10) Pub. No.: US 2010/0186468 A1
(43) Pub. Date: Jul. 29, 2010

(54) MOBILE PROBE COMPOSTING METHOD AND CORRESPONDING DEVICE

(75) Inventors: Monique Kallassy, Paris (FR); Olivier Lemaire, Levignen (FR); Maelenn Poitrenaud, Jouy Le Moutier (FR)

Correspondence Address: YOUNG & THOMPSON, 209 Madison Street, Suite 500, Alexandria, VA, 22314, US

(73) Assignee: VEOLIA PROPRETE, Nanterre (FR)

(21) Appl. No.: 12/666,856

(22) PCT Filed: Jun. 26, 2008
(86) PCT No.: PCT/FR2008/051174

§ 371 Date: Apr. 8, 2010

(30) Foreign Application Priority Data
Jun. 28, 2007 (FR) 0704667

(51) Int. Cl. C05F 17/00; C05F 17/02

(52) U.S. Cl. 71/9; 435/290.1

(57) ABSTRACT

A composting method, and corresponding device, for an organic mass placed in a composting zone, includes the following steps: measuring, with a probe, in at least one measuring point of the composting zone, at least one physic-chemical parameter, and aerating the organic mass. The method is basically characterized in that the probe is inserted in the organic mass, and in that aeration includes a step of sequential blowing, a function of the measuring step. Advantageously, the probe is mobile so that it can cover any point of the composting zone.

The present invention relates to the composting field.

Composting is a biological method for decomposing organic components of sub products and wastes, under aerobic conditions, into a stable, humic compound-rich organic product: compost.

These wastes, be they domestic wastes, green wastes, sludge, agricultural wastes, and/or industrial wastes are designated hereunder as organic mass.

The natural degradation of organic matter during composting is carried out by biological agents (microorganisms) the activity of which depends on physic-chemical parameters, particularly, on temperature and oxygen content. Accordingly, this activity may be evaluated by monitoring the temperature and oxygen content of an organic mass.

Usually, we seek to enhance the degrading action by optimizing the environmental conditions, especially, by means of aeration which renews the oxygen content of the organic mass, promoting the activity of aerobic bacteria.

The organic mass is disposed either in a flat recipient, or enclosure, that is, on the ground, or on an appropriate surface, for an opencast windrow for example, or in a partially or completely covered recipient or enclosure, or even in a closed reactor (completely closed enclosure such as a box, caisson, tunnel, container or closed lobby the size of which may typically vary from a few tens to hundreds of m3).

The organic mass thus disposed with its possible recipient (or enclosure) defines a composting zone. A composting zone is formed of a tridimensional set of elementary volumes.

According to a fist aspect, the invention more particularly relates to a method of composting an organic mass disposed within a composting zone formed of a tridimensional set of elementary volumes, comprising the steps of:
measuring, by means of a probe, at least a physic-chemical parameter of the composting zone, and
aerating the organic mass according to the result of the measuring step.

It is known by a man skilled in the art the prior art document WO 9012893. This patent provides a stationary probe located longitudinally at the heart of a windrow in an enclosure. The probe comprises a plurality of temperature sensors, and makes it possible to measure the temperature during the displacement of the organic matter within the enclosure and such that it regulates the temperature thereof by controlling an enclosure aeration system.

Nevertheless, such a teaching can be applied only to closed enclosures and the displacement of the organic mass is neither always possible, nor desirable.

Moreover, due to waste heterogeneity, the measurement of physic-chemical parameters monitored during composting are not identical at any point of a waste mass undergoing composting, either in an open composting system (composting windrow) or in a closed reactor.

In other words, the degrading reactions of the organic matter within an organic mass undergoing composting are not homogeneous and the measurement values of these physic-chemical parameters are not identical at any point of the mass undergoing composting. The control of aeration according to the aforementioned prior art is thus carried out with regard to a measurement which is not representative of the reactions within the entire compost mass and thus, the aeration is not optimally adapted to the oxygen needs of the microorganisms providing waste biodegradation.

Other methods, based on manual measurements at a single point of the organic mass by means of a probe manually implemented therein, exist. Such solutions are not satisfying, in that they might exhibit safety problems to operators carrying out the measurements (sounding), and settlement problems of the mass undergoing composting under the weight of said operators interfering with the measurements. Besides, they only provide a partial insight into the organic mass characteristics.

The present invention is aimed to overcome these drawbacks by providing a solution intended to notably ensure the monitoring of the organic matter degradation progress over the entire organic mass.

With this in mind, the device according to the invention, which is further in accordance with the aforementioned preamble, is substantially characterized in that:
the measuring step is carried out at a measurement point belonging to an elementary volume freely selected from the set of elementary volumes forming the composting zone.

Owing to this configuration, it is possible to monitor the parameters, as well as their progress, at a plurality of measurement points in the entire volume (in three dimensions) of the organic mass.

Preferably, with regard to the measuring step, the probe is removably introduced within the organic mass.

In an embodiment, the position of a measurement point is controlled depending on the result of one of the preceding measurements.

In an embodiment, a plurality of probes according to the invention may be implemented.

According to another aspect, the invention also relates to a composting device which is able to implement the method according to any one of the preceding claims, comprising:
a composting zone formed of a tridimensional set of elementary volumes,
aeration means (400),
means (10) for measuring at least a physic-chemical parameter in at least a point of the composting zone, and
means for regulating the aeration means (300), coupled to the measuring means.

The device according to the invention is substantially characterized in that the measuring means (10) are able to perform a measurement in a measurement point belonging to an elementary volume freely selected from the set of elementary volumes composing the composting zone.

Preferably, the measuring means comprise a movable probe.

Advantageously, the measuring means comprise a retractable probe.

The probe is provided with at least a sensor for measuring a physic-chemical parameter.

In an embodiment, the probe is mounted on a support shaft, such that:
the probe is mounted movable in translation along the support shaft, and/or
the support shaft is mounted movable in translation along at least a guiding rail.

In an embodiment, the probe is mounted on an articulated and/or extendable arm.

In an embodiment, both preceding embodiments being combined, that is, the probe is mounted on an articulated and/or extendable arm, and the articulated and/or extendable arm is mounted on a support shaft, such that:
the arm is mounted movable in translation along the support shaft, and/or
the support shaft is mounted movable in translation along at least a guiding rail.

In an embodiment, the composting zone is provided with a plurality of aeration points, the operation of at least one of which may be driven by means of the regulating means.

Advantageously, the probe is provided with positioning means, in this case, a position sensor (two or three-dimensional). The positioning along the vertical axis may also be easily determined once the initial attitude of the extension of the arms on which the probe is mounted is known.

These positioning means make it possible to improve the driving of the compost, by allowing, for example, the probe to return to the previous measurement points where the values of the physic-chemical parameters are put in a disadvantage with regard to the degrading process of the organic matter.

Preferably, the measuring probe comprises a plurality of sensors, which may be identical, respectively defining a plurality of points for measuring the physic-chemical parameters located along the probe.

Owing to this configuration, many measurements may be performed simultaneously at a plurality of measurement points.

In an embodiment, each sensor measures a particular physic-chemical parameter.

Owing to the invention, an automatic system providing a better safety with the regard to the operators as no intervention on the composting mass is needed for the introduction or the removal of the probe is provided. Moreover, any settlement of the composting mass caused by a human intervention during composting is thus avoided.

This probe is able to measure the temperature over a plurality of depths and to measure one or more types of gases as well as other physic-chemical parameters. Preferably, the physic-chemical parameter is comprised in the group consisting of (temperature, pH, moisture content, electric conductivity, thermal conductivity, partial pressure, gas content such as O2/CO2/CH4/N2/COV, etc.).

Thus, thanks to the invention it is possible to control a composting method through a movable probe making it possible to perform a set of multiple-points measurements.

Owing to this configuration, the measure of the various physic-chemical parameters of the organic mass may be performed by means of a movable probe able to carry out measurements at any point of the compost mass. And the control of the aeration may be ensured thanks to these measures.

Consequently, the invention make it possible to monitor the progress of the organic mass degrading at any point of the organic mass thanks to measurements made in elementary volumes, to identify the critical points and to possibly intervene on the control system in order to improve the degrading conditions.

Advantageously, the aeration (blowing and/or suction) is controlled through means, in this case computer-based, which notably determine the profile of the air flowrate at the injection head depending on the measured parameter values.

Other characteristics and advantages of the present invention will become more apparent from the following description given only by way of an illustrative, and in no way limitative, example and made with reference to the appended drawings wherein:

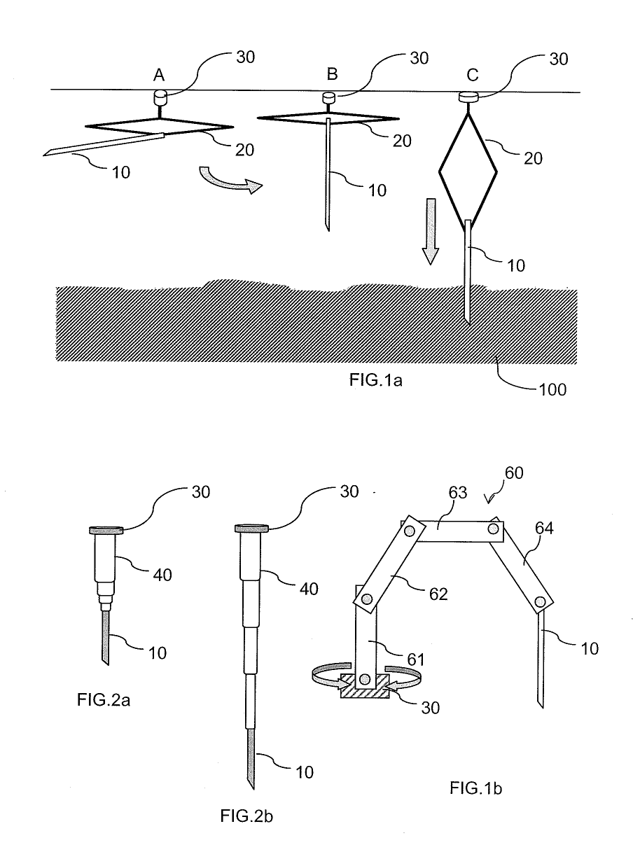

FIG. 1a represents three configurations of a movable probe according to an embodiment;

FIG. 1b represents an embodiment of a probe according to the invention;

FIG. 2a represents another movable probe type according to the invention, in a fold-back position;

FIG. 2b represents probe of FIG. 2a in an active position;

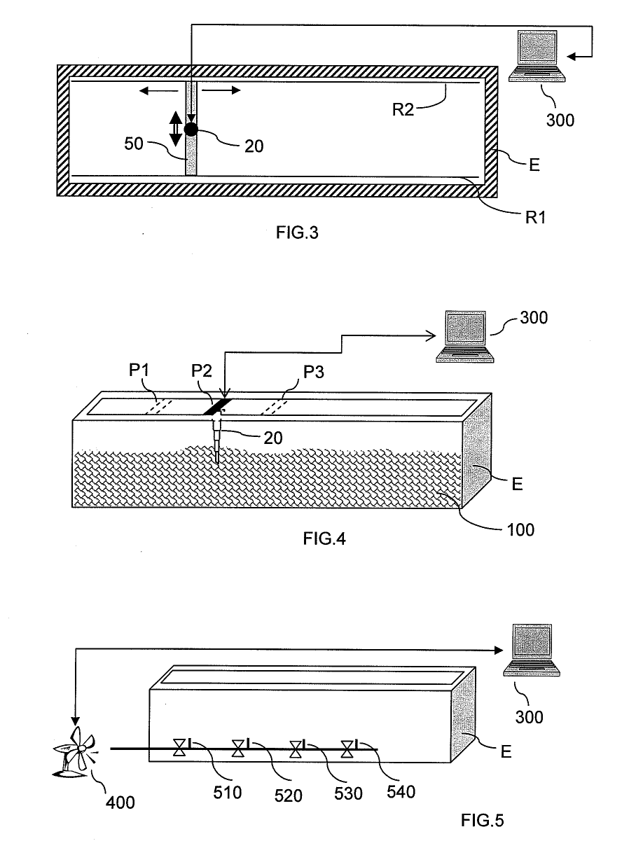

FIG. 3 represents an embodiment of the device according to the invention;

FIG. 4 represents another embodiment of the device according to the invention;

FIG. 5 represents an embodiment in which the blown gaseous composition is routed to the organic mass through piping means;

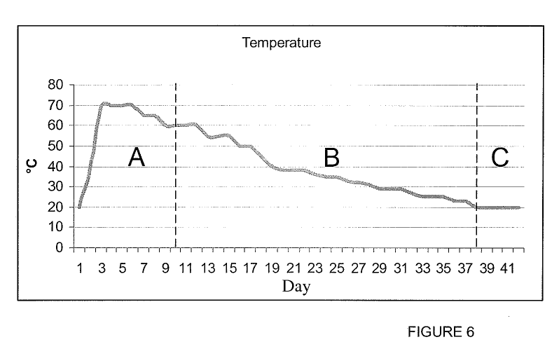

FIG. 6 illustrates a composting reference model representing the progress, over time, of an organic mass temperature.

The probe according to the invention is a movable probe, which selectively adopts a fold-back position at rest, and an active position for measurement. The mobility of the probe makes it possible to freely select a measurement point belonging to an elementary volume among the set of elementary volumes forming the composting zone.

Whatever the type is, each sensor implemented in the invention is known per se. thus, for clarity reasons, no description or representation will be made hereafter with regard to the sensors. Each sensor describes, for example, a measurement point belonging to an elementary volume among the set of elementary volumes forming the composting zone.

The configuration represented at FIG. 1a is particularly adapted to the composting enclosures provided with vertical and/or horizontal walls above the organic mass. Upon filling the enclosure, the probe is shielded in its fold-back position, then, at the completion of the filling, the probe is brought o its active position by retractably penetrating into the organic mass.

A retractable probe makes it possible to notably reduce the friction forces between the probe and the organic matter during relative movement. Moreover, this facilitates the maintenance of the probe and increases its service life because the contact between the probe and the corrosive organic matter may take place only for the measuring time period, the probe returning to its fold-back position between two series of measurements.

Probe 10 according to the invention is mounted on one end of articulated support arms.

The other end of the articulated support arms is connected to attaching means 30.

With reference to FIG. 1a, position A represents probe 10 according to the invention mounted on one end of articulated support arms 20, in its fold-back position. In this position, probe 10 is in a substantially horizontal position and the articulated support arms are in a fold-back position.

Position B represents probe 10 according to the invention in an intermediary position. The articulated support arms 20 are still in a fold-back position but the probe is brought in a substantially vertical position, through a movement illustrated by the solid arrow, before its introduction within the composting mass.

Position C represents probe 10 in the active position, that is, introduced within the organic mass 100, through a substantially vertical movement illustrated by the solid arrow and initiated by the articulated support arms 20 in the unfold position.

The displacement of the probe is allowed by the articulation of the articulated support arms 20.

In another embodiment, represented on FIG. 1b, probe 10 is connected to attaching means 30 by means of another articulated arm 60.

This articulated arm 60 comprises a plurality of segments 61-6 articulated by pairs, in this case pivotally mounted according to a transversal axis, and of which number and size vary.

Moreover, segment 61 connecting arm 61 to the attaching means 30 may be rotationally mounted according to the longitudinal axis of this segment 61 connecting arm 61 to the attaching means, as indicated by the solid arrows.

In another embodiment, represented on FIG. 2, the probe support arms are extendable.

Probe 10 is fixed on one end of an extendable support (jack) arm 40 comprising a plurality of segments, making it possible to cause the probe to penetrate up to a determined depth within the organic mass.

The number of segments (typically, from 1 to 10) and the length of each segment (typically, 25 cm) are determined such that the physic-chemical parameters may be measured over the entire height of the organic mass.

FIG. 2a represents the probe in the fold-back position and FIG. 2b represents it in the active position.

FIG. 3 represents another embodiment.

Probe 20 may be probe 10 such as described on the previous FIGS. 1a, 1b, 2a or 2b.

The configuration represented on FIG. 3 is particularly adapted to allow mobility in a substantially horizontal plane.

In this embodiment, the probe is connected to positioning means which allow the mechanical or automatic positioning thereof at any point of an enclosure E.

To this end, the positioning means comprise for example support means, in this case, a support shaft 50. Probe 20 may be movably mounted along this support shaft in a translational movement represented par the double arrow of FIG. 3.

The probe is held on the support shaft by the attaching means 30.

The positioning means also comprise a pair of guiding rails R1 and R2 mounted parallel, and preferably along two walls opposed over the length of enclosure E. rails R1 and R2 may be fixed on the walls, ceiling, or on specific stands in the form of an autonomous gantry for example for opencast composting systems.

The support means 50 are movably mounted between these two rails. The combination of the movements along the rails and along the support means makes it possible to spatially guide the probe and to cover the entire surface of enclosure E, and thus of the organic mass, in a mobile bridge fashion.

For example, as represented on FIG. 4, the probe performs a first measure or series of measures at position P1, then, a second measure at position P2, a third at position P3, etc. At each position P1, P2, P3, probe 20 may be brought at different depths, for example, thanks to articulated or extendable arms such as previously described, so as to carry out measurements over the entire depth of the organic mass 100.

The probe positioning is made possible either mechanically or automatically by connecting the probe to computer means 300 which notably allow the control of the positioning means.

Besides the positioning of the probe and/or of support means, the computer means 300 are also configured so as to control the spatial frequencies (measurement pitch and depth) and the measurement time frequencies of the physic-chemical parameters selected by the operator.

A first phase consists for example in measuring the values of physic-chemical parameters selected by the operator according to a first preset meshing, that is, a first measuring pitch, depending for example on the volume of the composting zone, over the totality thereof.

For example, the measuring pitches are at least of 50 cm, in this case an horizontal measuring pitch of 2 m, and depths of at least 50 cm. The selected horizontal pitch as well as the measuring depth define in this case an elementary volume. The measuring frequencies may vary between 12 hours and 7 days depending on the measured physic-chemical parameter, and/or the composting progress condition as described hereafter.

The control of the probe makes it possible to perform measurements of the physic-chemical parameters in a geographically random manner or preferably in a manner preset beforehand.

Advantageously, the measurements are carried out in all the elementary volumes of the organic mass.

The measurement results as well as the probe position (horizontal and vertical) are advantageously recorded in a data base.

Once the first phase completed, the invention advantageously comprises a step of comparing, for a given elementary volume, the measurement result to a reference model.

Depending on the gap between the measurement result and the reference model, in this case (for parameters such as temperature, or oxygen content) when the measured value is lower (possibly, higher for gases other than oxygen) than the reference value for a given number of composting days, the probe may be sent back to the more disadvantaged points (elementary volumes), and possibly to the points adjacent thereof, in order to perform a second phase of measurements according to a second preset meshing, the pitch of which is lower than that of the first meshing, and thus obtain a more sharp “image” of the composting zone for the more disadvantaged elementary volumes; and possibly, providing a better control of the aeration at any point of the organic mass.

Thus, the position of a measurement point may be subjected to the result of one of the preceding measurements.

FIG. 6 illustrates a reference model example providing temperature progress over time. On this figure, three composting progress states may be defined in a purely illustrative way. In a first composting progress state A′, the reference temperature is of 70° C. for a first number of composting days (for example, from 1 to 10 composting days). In a second progress state B′, the reference temperature is of 60° C. for a second number of composting days (for example, from 11 to 38 composting days). And in a third progress state C′, the reference temperature is of 20° C. for a third number of composting days (for example more than 39 composting days). Preferably, the invention comprises a progress state per composting day, that is, a target temperature value per composting day.

The measurements of the physic-chemical parameters may be carried out at a fixed or variable frequency. In this case, the measurements are carried out according to a first frequency f1 (for example, 12 to 24 hours) during the first progress state A′ a second different frequency f2 (for example, 1 to 7 days) during the second progress state B′, and possibly, a third different frequency (for example, 8 to 15 days) during the third progress state C′.

Each one of the measurement frequencies f1, f2 and f3 advantageously depends on the type of waste of the organic mass. Preferably, they also depend on the system inertia, that is, the time required for the stabilization of the measured parameter. They may also depend on the gap against the reference model value.

The measurement frequencies f1, f2 and f3 are defined particularly for the first phase and possibly for the second phase. Meanwhile, the measurement frequency f4 for the second phase may be set different from the measurement frequencies f1, f2 and f3 for the first phase.

Once the second measuring phase, made according a preset mashing, performed, the first preset measurement pitch may be used for a subsequent measurement cycle.

Thanks to the invention, a two or three dimensional mapping of the organic mass may thus be obtained, with an ultimately variable pitch.

The control means, in this case in the form of computer means 300, make it possible to control the aeration flowrate and duration based on target values of the physic-chemical parameters defined according to the progress of the organic matter degrading process (the composting phases). Typically, the target values corresponding to the reference model values for a given number of composting days.

The control of the aeration of the composting mass is made depending on the selected aeration method (continuous, discontinuous or time-out aeration).

The aeration means comprise blowing means 400, in this case a fan, controlled by the control means. Air, or an appropriate gaseous composition—for example, oxygen enriched—is blown and provided to the organic mass, according to a plurality of embodiments.

In a first embodiment, the gaseous composition is provided to the organic mass such that the distribution of the gaseous composition within or around the organic mass is made homogenous. To this end, the organic mass is disposed on a plate provided with holes or on a grid under which either the blowing means are directly located, or the end of a conduit the other end of which being connected to the blowing means.

In a second embodiment, the gaseous composition is provided to the organic mass through piping means, represented on FIG. 5, such that the distribution of the gaseous composition within or around the organic mass is not homogenous.

To this end, the piping means comprise means for connection to the blowing means and at least one injection head, for directing the gaseous stream towards (or within) the organic mass.

Thanks to this arrangement, the distribution of the gaseous composition may be adapted to the local requirements, that is, a measurement Mi at a given point Zi (local measurement zone) may be carried out, and the amount Qi of gaseous composition to be provided to that area Zi may be determined, a measurement Mj at another given point Zj determining the amount Qj of gaseous composition to be provided to this area Zj may be determined, with values Qj and Qi being ultimately different.

For example, the piping means comprise a plurality of conduits the respective injection heads of which 510, 520, 530, 540 being disposed proximate to or within the organic mass.

Advantageously, each injection head is equipped with respective regulating means, in this case a solenoid valve, controlled by the control means. Advantageously, the injection heads are independent from one another, that is, each one may have specific aeration flowrate and duration. Preferably, the aeration flowrate and duration for each injection head is determined according to the measurements carried out by the probe and according to a reference model stored in the control means.

Preferably, the injection heads are further movable and controllable, mounted on articulated conduits, for example, extendable ducts, so as to precisely inject the gaseous composition within the organic mass at the required areas the position of which have been determined beforehand by the measurements of the probe, notably according to the gap between the measurement result and the reference model.

Owing to this configuration, the organic mass aeration may be selective and/or sequential, and optimal with regard to the microbiological activity.

The present invention is not limited to the embodiments described above.

For example, depending on the configuration of the composting zone, position B on FIG. 1 may represent the probe fold fold-back position.

The probe introducing movement may be substantially diagonal or horizontal.

The arms supporting the probe may comprise other mobile configurations, for example, rotation-type or screw-type systems.

The described probe may be replaced by a plurality of probes.

The blowing means may comprise a plurality of fans.

For concision purposes, the present description has described only a static organic mass. Nevertheless, the present invention may also be implemented within enclosures comprising means for moving the organic mass.

Preferably, the probe is made of materials which withstand the composting corrosive atmosphere, for example, stainless steel materials.

The various parts of the probe are preferably made of a solid matter able to withstand the pressure the probe sustained by the probe during its introduction within the waste organic mass.

For example, the diameter of the arms and of the probe is computed according to the waste density, the order of magnitude being typically in centimeters. The probe arms length is preferably determined according to the height of the composting organic mass, the order of magnitude being of a few meters, typically, between 2 and 4 m.

The probe is connected to means for controlling the aeration means through any appropriate wired or wireless means.

Thanks to the invention, a single probe may be used to carry out plural measures at any point of the composting zone.

Further, in another embodiment of the device according to the invention, the measuring means 10 comprise means for measuring the physic-chemical parameters, such as moisture content, in this case an infrared sensor.

Preferably, the means for measuring the moisture content are mounted on a support shaft 50, so as to make it possible to perform a series of measures, possibly continuous, on surface above the organic mass.

Advantageously, the measurement of the moisture content of the organic mass may thus be performed without necessarily introducing the probe within the organic mass.

This measuring step, according to the invention, is advantageously implemented following a step of homogenizing the organic mass.

1-10. (canceled)

11. A method for composting an organic mass disposed in a composting zone formed of a three-dimensional set of elementary volumes,
comprising the steps of:
in a first phase, automatically measuring by means of a mobile probe, according to a first meshing, at least a physic-chemical parameter of the composting zone, and
aerating the organic mass based on the result of the measurement step,
characterized in that it further comprises the steps of:
comparing, for a given elementary volume, the measurement result with a reference model,
depending on the gap between the measurement result and the reference model, performing a second measurement phase for at least said given elementary volume, according to a second meshing lower that the first meshing.

12. The composting method according to claim 11, wherein the reference model is the temperature progress on the basis of the number of composting days.

13. The composting method according to claim 11, wherein the measurement frequency (f1, f2, f3) for the first phase varies according to the composting progress state.

14. The composting method according to claim 12, wherein the measurement frequency (f4) for the second phase differs from the measurement frequency (f1, f2, f3) for the first phase.

15. A composting device, capable of carrying out the method according to claim 11, comprising:
a composting zone formed of a three-dimensional set of elementary volumes,
aeration means (400),
means (10) for measuring at least one physic-chemical parameter at least at a point of the composting zone, and
means for regulating the aeration means (300), coupled to the measuring means,
characterized in that the measuring means (10) comprise a mobile probe able to automatically perform a measurement at a measurement point belonging to an elementary volume freely selected from the set of elementary volumes forming the composting zone.

16. The composting device according to claim 15, wherein the probe is retractable.

17. The composting device according to claim 15, wherein the probe is mounted on a support shaft (50), such that
the probe is mounted movable in translation along the support shaft, and/or
the support shaft is mounted movable in translation along at least one guiding rail (R1, R2) transversal to the shaft.

18. The device according to claim 15, wherein the probe is mounted on an articulated and/or extendable arm (20, 40, 60).

19. The composting device according to claim 15, wherein the composting zone is provided with a plurality of aeration points (510, 520, 530, 540), the operation of at least one of them being controllable by the regulating means.

20. The composting method according to claim 13, wherein the measurement frequency (f4) for the second phase differs from the measurement frequency (f1, f2, f3) for the first phase.

21. The composting device according to claim 16, wherein the probe is mounted on a support shaft (50), such that
the probe is mounted movable in translation along the support shaft, and/or
the support shaft is mounted movable in translation along at least one guiding rail (R1, R2) transversal to the shaft.
